(19) United States
(12) Patent Application Publication
(10) Pub. No.: US 2008/0259550 A1
(43) Pub. Date: Oct. 23, 2008

(54) CRADLE FOR HANDHELD ELECTRONIC DEVICE

(75) Inventor: Jerry Lien, Sijhih City (TW)

Correspondence Address: PAI PATENT & TRADEMARK LAW FIRM, 1001 FOURTH AVENUE, SUITE 3200, SEATTLE, WA, 98154, US

(73) Assignee: MICROTIPS TECHNOLOGY INC., Sijhih City (TW)

(21) Appl. No.: 11/736,684

(22) Filed: Apr. 18, 2007

(51) Int. Cl. H05K 7/00

(52) U.S. Cl. 361/683

(57) ABSTRACT

A cradle includes a base, and a function module and an adjusting unit mounted in a receiving space of the base. The base has an external insertion recess for a handheld electronic device to insert therein, and being communicable with the receiving space via a through-wall slot. The function module is electrically connectible to an external power supply, and includes a first connector that is extended through the through-wall slot into the insertion recess for electrically connecting to the handheld electronic device, and is smaller than the through-wall slot. The adjusting unit includes a press plate fixedly connected at an end to the function module, at least one elastic element, and at least one pivot bolt extended through the elastic element and the other end of the press plate into a wall of the base, such that the elastic element is movably connected to the press plate.

### FIELD OF THE INVENTION

The present invention relates to a cradle for handheld electronic device, and more particularly to a cradle that includes mechanisms for protecting a connector of the cradle against oblique pull and damage by a handheld electronic device electrically connected to the cradle via the connector.

### BACKGROUND OF THE INVENTION

Please refer to FIG. 1 that is a sectioned side view of a conventional cradle, to which a handheld electronic device 90, such as an i-POD or a mobile phone, may be electrically connected in order to perform a specific function, such as mixing sounds or charging the electronic device. The cradle includes a base 91, and a function module 92 mounted in the base 91. The base 91 has an insertion recess 911 defined by the peripheral walls of the base 91 for holding the handheld electronic device 90 therein. The function module 92 is connectable to an external power supply, and includes a connector 93 extended into the insertion recess 911 for inserting into and electrically connected to a connecting port (not shown) on the handheld electronic device 90. With the function module 92, the handheld electronic device 90 set in the insertion recess 911 of the cradle and connected to the connector 93 is able to perform a predetermined function. For example, sound mixing can be done on an i-POD externally connected to a computer via the cradle, or an externally connected mobile phone can be electrically charged via the cradle.

The function module 92 is fixedly embedded in the base 91 of the cradle. When the connected handheld electronic device 90 has a size smaller than that of the insertion recess 911, the device 90 is not in direct contact with and supported by the base 91, but applies its whole weight on the connector 93 of the function module 92 during the period of performing the specific function. The weight of the handheld electronic device 90 plus a force applied by a user operating the device 90 apparently applies an oblique force on the connector 93. When the connector 93 is subjected to the oblique force over a long time, tin cracks tend to occur at a contact of the connector 93 to cause poor contact of the connector 93 with the electronic device 90. In a worse condition, the function module 92 might not be able to electrically connect to the electronic device 90 any longer to seriously reduce the usable life of the cradle.

### SUMMARY OF THE INVENTION

A primary object of the present invention is to provide a cradle for handheld electronic device that allows the handheld electronic device positioned thereon to elastically adjust position without undesirably pull and damage a connector connecting the handheld electronic device to the cradle.

To achieve the above and other objects, the cradle for handheld electronic device according to the present invention includes a base, a function module, and an adjusting unit. The base includes an internal receiving space, an external insertion recess defined by peripheral walls of the base for a handheld electronic device to insert therein, and a through-wall slot communicating the internal receiving space with the external insertion recess. The function module is mounted in the internal receiving space and electrically connected to an external power supply, and includes a first connector extended from the internal receiving space into the insertion recess via the through-wall slot for electrically connecting to a connecting port provided on the handheld electronic device. The first connector has a cross-section area smaller than the through-wall slot. The adjusting unit is mounted in the internal receiving space, and includes a press plate fixedly connected at an end to the function module, at least one elastic element, and at least one pivot bolt extended through the elastic element and the other end of the press plate into a wall of the base for the elastic element and the press plate to movably connected to each other. When the handheld electronic device is inserted in the insertion recess to electrically connect to the first connector, the handheld electronic device applies a weight on the first connector, bringing the first connector to displace in the through-wall slot, and the displaced first connector further brings the whole function module and accordingly, the press plate of the adjusting unit to move downward and thereby compress the elastic element.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a sectioned side view of a conventional cradle for handheld electronic device;

FIG. 2 is a sectioned side view of a cradle for handheld electronic device according to a first preferred embodiment of the present invention;

FIG. 3 is a sectioned side view of the cradle for handheld electronic device of FIG. 2 showing a handheld electronic device held therein is elastically adjusted to a suitable position in the cradle;

FIGS. 4 and 5 are partially exploded perspective views showing a functional module and an adjusting unit included in the cradle of FIG. 2;

FIG. 6 is a fragmentary top view showing the arrangement of the functional module and the adjusting unit;

FIG. 7 is a side view of FIG. 6;

FIG. 8 is a sectioned side view of a cradle for handheld electronic device according to a second preferred embodiment of the present invention; and

FIG. 9 is a sectioned side view of the cradle for handheld electronic device of FIG. 8 showing a handheld electronic device held therein is elastically adjusted to a suitable position in the cradle.

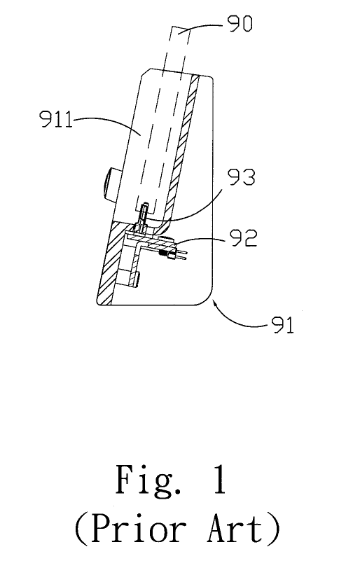

### DETAILED DESCRIPTION OF THE PREFERRED EMBODIMENTS

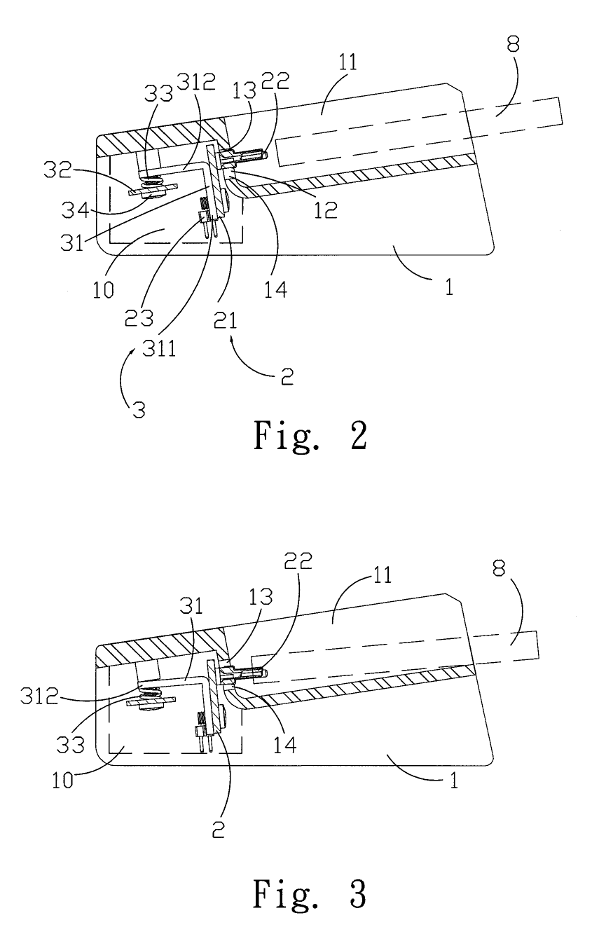

Please refer to FIGS. 2 and 3 that are sectioned side views of a cradle for handheld electronic device according to a first preferred embodiment of the present invention. As shown, the cradle of the present invention is suitable for a handheld electronic device 8 that has a connecting port (not shown) provided thereon, and may be, for example, a mobile phone, an i-POD, etc. More particularly, the cradle of the present invention is suitable for handheld electronic devices 8 of different thickness and provided with a connecting port. The cradle includes a base 1, a function module 2, and an adjusting unit 3.

The base 1 includes an internal receiving space 10, and an external open-topped insertion recess 11 defined by peripheral walls of the base 1 to adjoin the internal receiving space 10. The insertion recess 11 has an open front end opposite to the internal receiving space 10, and is formed on a rear end with a through-wall slot 12, via which the insertion recess 11 is communicable with the receiving space 10. The function module 2 and the adjusting unit 3 are mounted in the internal receiving space 10. The handheld electronic device 8 may be inserted into the insertion recess 11. The through-wall slot 12 has two opposite ends, namely, an upper first end 13 and a lower second end 14.

In the illustrated first preferred embodiment, the insertion recess 11 has an open top and an open front end. Of course, the insertion recess 11 may be otherwise configured to have an open front end only. However, with the open-topped insertion recess 11, a user can more conveniently access and operate a front panel (not shown) of the handheld electronic device 8 inserted in the insertion recess 11.

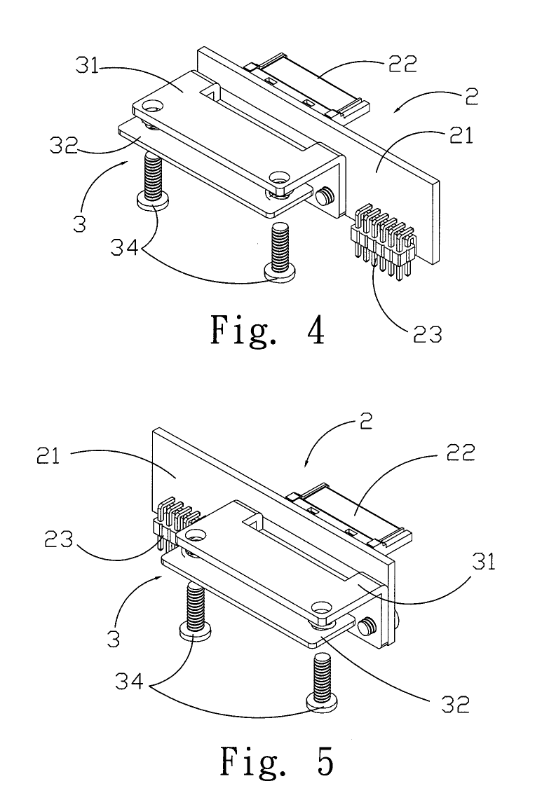

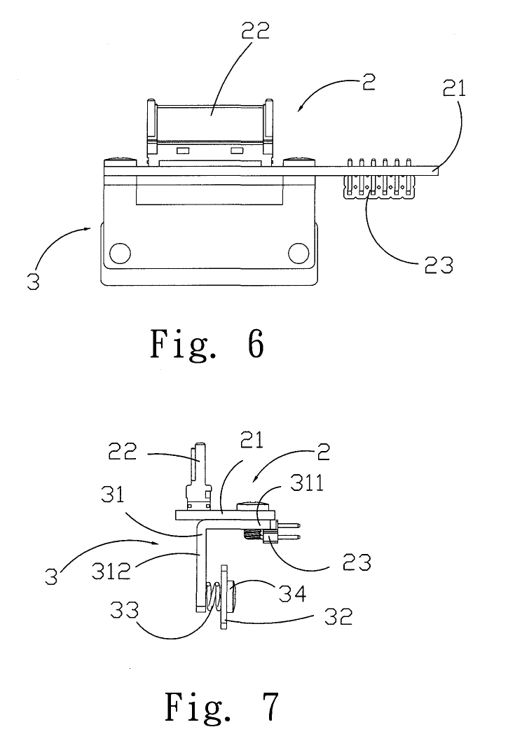

Please refer to FIGS. 4 through 7. The function module 2 includes a circuit board 21, and a first connector 22 and a second connector 23 mounted on and electrically connected to the circuit board 21. In the first preferred embodiment of the present invention, the first connector 22 is located at a front side of the circuit board 21 facing toward the through-wall slot 12, and the second connector 23 is located at a rear side of the circuit board 21. The circuit board 21 and the second connector 23 are located in the internal receiving space 10 of the base 1, while the first connector 22 is extended from the receiving space 10 through the through-wall slot 12 into the insertion recess 11. The first connector 22 is configured corresponding to the connecting port provided on general handheld electronic devices, so that the handheld electronic device 8 is held in the insertion recess 11 with the first connector 22 inserted into the connecting port of the device 8 and thereby electrically connected to the cradle. The second connector 23 is provided for electrically connecting to an external power supply (not shown) , allowing the cradle to obtain required operating power. It is noted the through-wall slot 12 is slightly larger than a cross-section area of the first connector 22, so that the first connector 22 may displace upward and downward relative to the through-wall slot 12.

The adjusting unit 3 is mounted in the internal receiving space 10, and includes a press plate 31, a clamping plate 32, at least one elastic element 33, and at least one pivot bolt 34. The press plate 31 is an L-shaped member having a fixing section 311 fixed to the rear side of the circuit board 21 and a pressing section 312 perpendicular to and extended from an upper edge of the fixing section 311. The clamping plate 32 is a flat plate located below and spaced from the pressing section 312 of the press plate 31. In the illustrated first preferred embodiment, the elastic element 33 is a coil spring being located between the pressing section 312 of the press plate 31 and the clamping plate 32. The pivot bolt 34 is upward extended through the clamping plate 32, the elastic element 33, and the pressing section 312 to screw into the peripheral wall atop the receiving space 10, so that the press plate 31, the clamping plate 32, and the elastic element 33 are axially movably connected to one another.

Preferably, there are two sets of elastic element 33 and pivot bolt 34 evenly spaced on and located at two lateral sides of the press plate 31 and the clamping plate 32 to enable increased stability of the adjusting unit 3.

Please refer to FIGS. 2 and 3 again. When it is desired for the handheld electronic device 8 to perform a certain predetermined function, such as mixing sounds or charging the device 8, via the cradle, simply position the electronic device 8 in the insertion recess 11 for the first connector 22 to insert into and electrically connect to the connecting port on the electronic device 8. The handheld electronic device 8 applies a weight on the first connector 22, causing the first connector 22, and accordingly, the whole function module 2 and the press plate 31 to move downward until the electronic device 8 is in contact with an inner bottom wall of the base 1 in the insertion recess 11. At this point, the first connector 22 is displaced from the upper first end 13 to the lower second end 14 of the through-wall slot 12; and the at least one elastic element 33 is downward compressed by the press plate 31 to store a restoring force.

When the predetermined function has been completed and it is desired to remove the handheld electronic device 8 from the cradle, simply forward extract the electronic device 8 from the insertion recess 11 on the base 1 to separate the first connector 22 from the connecting port of the electronic device 8, so that the first connector 22 along with the whole function module 2 and the press plate 31 are released from the weight of the handheld electronic device 8. At this point, the restoring force of the at least one elastic element 33 automatically pushes the press plate 31 and the whole function module 2 upward, bringing the first connector 22 to return from the lower second end 14 to the upper first end 13 of the slot 12.

The cradle of the present invention is applicable to any handheld electronic device 8 that is dimensionally smaller than the insertion recess 11 of the base 1 and provided with a connecting port matching the first connector 22 of the function module 2. With the adjusting unit 3 and the through-wall slot 12, the first connector 22 of the function module 2 is allowed to displace upward and downward in the insertion recess 11 of the base 1. As a result, the handheld electronic device 8 connected to the first connector 22 is allowed to automatically adjust its position in the insertion recess 11 during the use or the operation thereof, and the first connector 22 is protected against undesirable pull and damage due to the weight applied thereto by the handheld electronic device 8. Therefore, the cradle for handheld electronic device according to the present invention may have extended service life and enhanced applicability.

In the first preferred embodiment of the present invention, the base 1 of the cradle is designed for horizontally lying on a surface, so that a user may conveniently operate the front panel of the handheld electronic device 8 inserted in the insertion recess 11 and connected to the first connector 22.

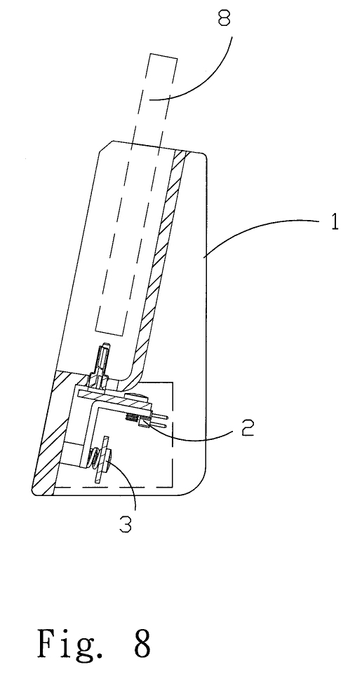

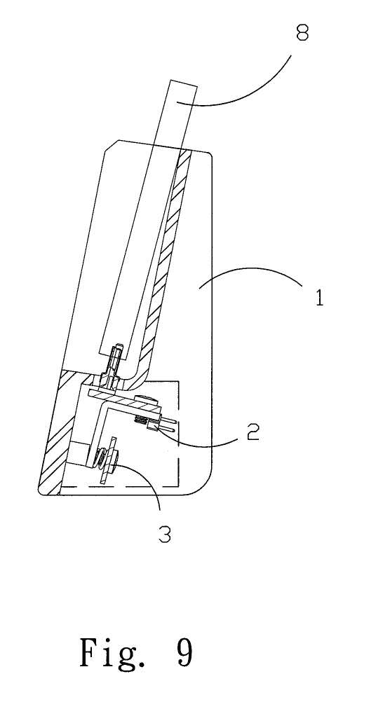

FIGS. 8 and 9 are sectioned side views of a cradle for handheld electronic device according to a second preferred embodiment of the present invention. The second embodiment is generally structurally similar to the first embodiment, except for a base 1 that is designed for standing upright, so that the handheld electronic device 8 can be more easily inserted into or removed from the insertion recess 11.

Since the first connector of the cradle of the present invention is displaceable within a predetermined range, allowing the handheld electronic device 8 to adjust its position in the insertion recess of the cradle without undesirably pulling the first connector 22, the first connector 22 is protected against poor contact with the circuit board 21 to increase the usable life of the cradle.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A cradle for handheld electronic device, comprising:
a base, which includes an internal receiving space, an external insertion recess defined by peripheral walls of the base for a handheld electronic device to insert therein, and a through-wall slot communicating the internal receiving space with the external insertion recess;
a function module mounted in the internal receiving space and electrically connectible to an external power supply; the function module including a first connector extended from the internal receiving space into the external insertion recess via the through-wall slot for electrically connecting to a connecting port provided on the handheld electronic device; and the first connector having a cross-section area smaller than the through-wall slot; and
an adjusting unit mounted in the internal receiving space, and including a press plate fixedly connected at an end to the function module, at least one elastic element, and at least one pivot bolt extended through the elastic element and the other end of the press plate into a wall of the base for the elastic element and the press plate to movably connected to each other;
whereby when the handheld electronic device is inserted in the insertion recess to electrically connect to the first connector, the handheld electronic device applies a weight on the first connector, bringing the first connector to displace in the through-wall slot, and the displaced first connector further brings the whole function module and accordingly, the press plate of the adjusting unit to move downward and thereby compress the elastic element.

2. The cradle for handheld electronic device as claimed in claim 1, wherein the adjusting unit further includes a clamping plate movably connected to the pivot bolt, such that the elastic element is located between the press plate and the clamping plate and compressible by the press plate.

3. The cradle for handheld electronic device as claimed in claim 1, wherein the press plate is an L-shaped plate having a fixing section for fixedly connected to one side of the function module, and a pressing section perpendicular to and outward extended from an upper edge of the fixing section; and the pivot bolt is extended through the pressing section of the press plate.

4. The cradle for handheld electronic device as claimed in claim 1, wherein the function module further includes a second connector for electrically connecting to the external power supply, and a circuit board, to which the first and the second connector are mounted and electrically connected.
